(19) United States
(12) Patent Application Publication
(10) Pub. No.: US 2003/0224022 A1
(43) Pub. Date: Dec. 4, 2003

(54) Hydrocolloid cellular solid matrices

(76) Inventor: Amos Nussinovitch, Rehovot (IL)

Correspondence Address: WINSTON & STRAWN, PATENT DEPARTMENT, 1400 L STREET, N.W., WASHINGTON, DC, 20005-3502, US

(21) Appl. No.: 10/371,205

(22) Filed: Feb. 24, 2003

Related U.S. Application Data
(63) Continuation-in-part of application No. 08/877,804, filed on Jun. 18, 1997, now Pat. No. 6,589,328.
Application No. 08/877,804 is a continuation-in-part of application No. 08/491,983, filed on Jul. 18, 1995, now abandoned.
Application No. 08/491,983 is a 371 of international application No. PCT/EP94/00107, filed on Jan. 17, 1994.

(30) Foreign Application Priority Data
Jan. 19, 1993 (IL) 104441

(51) Int. Cl. A61K 9/00; C12N 1/12; C12N 1/20; A61K 47/00

(52) U.S. Cl. 424/400; 424/439; 106/135.1; 435/252.1

(57) ABSTRACT

The invention relates to novel hydrocolloid cellular solid matrices having predetermined moisture absorption properties, caloric value, biodegradability, pore size, pore density, pore distribution and structure. Certain cellular solid matrices of the invention can be used as edibles, and these can be produced as calorie-less, low calorie, high calorie and ultra-high calorie content cellular solids. Certain types of cellular solid matrices can be used in medicine and also in a variety of industries.

### CROSS-REFERENCE TO RELATED APPLICATIONS

This is a Continuation-In-Part Application of application Ser. No. 08/877,804 filed Jun. 18, 1997, which application is a continuation-in-part of U.S. application Ser. No. 08/491,983 filed Jul. 18, 1995, now abandoned, which application is a national phase of PCT/EP94/00107 filed Jan. 17, 1994 which claims the benefit of IL application No. 104441 filed Jan. 19, 1993.

### FIELD OF THE INVENTION

The invention relates to novel hydrocolloid cellular solid matrices having predetermined moisture absorption properties, caloric value, biodegradability, pore size, pore density, pore distribution and structure. Certain cellular solid matrices of the invention can be used as edible materials, and these can be produced with no calorie value and as calorie-less, low calorie, high calorie and ultra-high calorie content cellular solids. Certain types of cellular solid matrices can be used in medicine and also in a variety of industries.

### BACKGROUND OF THE INVENTION

A cellular solid is an interconnected network of solid struts or plates which form the edges and faces of cells (Gibson and Ashby, 1988). Cellular materials such as cork whose first reported use was as bungs in wine bottles in Roman times, and other similar solids have been used for centuries. Recently, a variety of man-made cellular solids have been developed. They include honeycomb-like materials, and polymeric foams which are widely used in everyday life, for example for the production of disposable coffee cups, or for the construction of crash padding in an aircraft cockpit. Foaming techniques for polymers, metals, ceramics and glasses exist. These foams can be used for insulation, cushioning and absorbing the impact of kinetic energy.

The structure of cellular solid matrices ranges from the near-perfect order of the bee's honeycomb to the disordered, three-dimensional networks of cellular solid matrices and foams (Gibson and Ashby, 1988). There is a clear distinction between open-cell and closed-cell foams: In open-cell foam, the solid of which the sponge is contained is in the cell edges only (so that the cells connect the sponge through open faces). In closed-cell foam, the faces are solid too, so that each cell is sealed off from its neighbors. Of course some sponges (cellular solids) are partly open and partly closed. When foaming takes place, surface tension can be a dominant force responsible for drawing the solid material into the cell edges, leaving a thin cell face framed by thicker edges. If surface tension shapes the structure, four edges meet at 109.4° at each vertex, and three faces meet at 120° at each edge. Metal, ceramic and glass foams are good examples of this type of structure.

Many foods are solid foams. Bread usually has closed cells, expanded by the fermentation of yeast or by CO₂ from bicarbonate. Meringue is a foamed egg white with sugar. Foamed chocolate is an example of a food expanded to change its texture. Other hard brittle candies are also often expanded to make them attractive to consumers or if they are sold by volume, to make them cheaper. Other important “solid-foam” foods are breakfast cereals and snack foods, which are foamed with steam to produce texture and crunchiness.

Nussinovitch et al. (1993) demonstrated the production of mechanically stable sponges by immersing bicarbonate-containing agar and alginate gels in an acid bath, causing them to form internal gas bubbles, then freeze-drying them. These sponges exhibit characteristic compressive stress-strain curves and their properties are largely dependent on the conditions of their preparation. WO 94/17137 discloses the production of mechanically stable sponges from hydrocolloids by expansion of hydrocolloid gels. A copy of WO 94/17137 is incorporated herein in its entirety by reference.

There is an unmet need for hydrocolloid cellular solid matrices having predetermined structure, porosity, caloric value and composition.

### SUMMARY OF THE INVENTION

The present invention provides biodegradable cellular solid matrices formed from hydrocolloid gels, said cellular solid matrices having predetermined characteristics of moisture absorption, caloric value, biodegradability, pore size, pore density, pore distribution and structure. The different methods for producing said cellular solid matrices disclosed in the present invention enable control of the characteristics of such hydrocolloid gels.

The biodegradable cellular solid matrices of the invention are made from hydrocolloid gels produced from a hydrocolloid selected from the group consisting of agar, agarose, pectin, carrageenan, alginate, gelatin, gellan, konjak mannan, xanthan gum plus locust bean gum, or a combination thereof.

The present invention also relates to a method for the production of cellular solid matrices comprising:

a) expanding a hydrocolloid gel solution with a gas prior to or during gelation, wherein said gas becomes entrapped as bubbles within the matrix of said gel, and wherein said gel keeps its integrity; and

b) drying said expanded gel.

In one embodiment, the method for the production of cellular solid matrices further comprises freezing the expanded gel prior to its drying.

In a preferred embodiment, the concentration of said hydrocolloid gum solution before gelification does not exceed 20%, prior to expansion with gas and subsequent drying after gelation.

The gas used in the invention in order to expand the hydrocolloid gel is produced by different methods. In one embodiment, said gas is produced by microorganisms, said microorganisms being incorporated on the gel surfaces and within the hydrocolloid gel and being capable of producing a gas by fermentation or denitrification of a suitable substrate. In one embodiment, said microorganisms are yeast or bacteria. In another embodiment, said substrate is sucrose, glucose, fructose or a polysaccharide such as starch.

In another embodiment, said gas is released following a chemical reaction between a carbonate salt and an acid, wherein one of these ingredients is incorporated within the gel during its preparation. In one embodiment, the carbonate salt is incorporated within the gel during its preparation and the acid is diffused afterward in order to initiate the chemical reaction. In another embodiment, the acid is incorporated within the gel during its preparation and the carbonate salt is diffused afterward in order to initiate the chemical reaction. The gas produced during the chemical reaction is entrapped within the hydrocolloid gel to produce the expanded gel. In one embodiment, said carbonate salt is calcium carbonate and said acid is citric acid.

In another embodiment, a gas is released into a sealed chamber containing the gel. The chamber can previously be filled with fluid or may contain only gas. A gas is compressed into said chamber, said chamber being opened abruptly causing said gas to be dissolved and entrapped within the hydrocolloid gel, to produce the expanded gel. During the transition from high pressure to low pressure, gas bubbles which are present in the gel prior to the compression of gas are expanded.

In another embodiment, a gas sparger produces gas bubbles which are then entrapped within the hydrocolloid solution before final gelification.

In various embodiments of the invention, said gas is selected from carbon dioxide, oxygen, nitrogen, helium, other noble gases and air.

In yet another embodiment, oil is incorporated within a hydrocolloid gel prior to its expansion, followed by a slow heating process at a temperature below the gel melting point and drying. In a preferred embodiment, the gel is slow-heated in water having temperature of 85° C. for 5 to 15 min to induce the oil's removal from the gel into the warm water in which it is immersed. This process enables the transformation of the gel into a porous structure which produces a sponge upon drying.

In another embodiment of the present invention, an oil is incorporated within the hydrocolloid gel prior to its expansion and the gel is expanded by one of the above-mentioned methods. In these conditions the porosity of the expanded gel can be reduced. As detailed in Table 6, while the oil content in the gels prior to its expansion ranged between 0 to 28%, the oil content in the cellular solid matrices is up to 75%. At 40% oil inclusion within the gel before freeze-dehydration, porosities reduced from 95% (no oil inclusion) to 80% (40% oil inclusion).

Thus, according to one embodiment of the invention, the method for production of cellular solid matrices further comprises adding oil or fat to the hydrocolloid gel, preferably prior to the expanding of said gel with the gas, as a method to manipulate the gel porosity and structure. Since fat is solid at room temperature, the addition of fat may be useful to entrap the gas or oil-soluble drugs or factors within the gel.

In various embodiments of the present invention, the oil incorporated within the hydrocolloid gel prior to its expansion may be coconut, corn, cotton seed, linseed, olive, palm, peanut, rapeseed, soybean, sunflower as well as castor, tallow, tung. Other oils could be of animal origin such as beef and mutton tallow and sardine. Fats either from vegetable or animal source could also be used. These include butter, cocoa butter, shea butter, sal butter, lard and margarine.

In yet another embodiment, a sponge-like structure is produced by partial dissolution of the gel. In a preferred embodiment, agarose, optionally combined with other gelling agent is embedded in a solution of sodium iodide in conditions which permit partial dissolution of the gel. The partial dissolution enables creating pores within the matrix, that after drying will evolve in achieving the requested cellular solid.

The method of producing a cellular solid includes drying of the expanded gel, by any suitable means including by lyophilization or freeze drying, vacuum drying, fluidized bed drying, sun drying (in cases where a matrix which is similar to fruit leather is produced) or oven drying. The method of the present invention optionally comprises freezing the expanded gel prior to its drying in order to preserve the porosity of the gel. Drying the gel without freezing will form more condensed cellular solids. The dry cellular solid matrices will comprise residual moisture, which is necessary to maintain the integrity of the cellular solids. The percentage of the residual moisture left in the cellular solid after drying is up to 3%.

In one embodiment, the method of the invention further comprises incorporating within the expanded gel hydrophilic or hydrophobic additives, before or during gel setting. Such additives may be for example a flavor, a coloring material, a plasticizer, a salt, a preservative, an acidifying agent, a polysaccharide, a sweetener, a sequestering agent, an emulsifier, a filler, a cross linking agent, a food additive, a high calorie food ingredient, a low calorie food ingredient, a biological material, a microorganism, a drug or a combination thereof. In another embodiment, some additives such as flavoring, color and aroma ingredients may be added by spraying after the drying of the expanded gel.

One of the advantages of the sponge of the present invention is that by the inclusion of oil, sugar or starch within a gel, or by diffusion of other ingredients into the gel, it is possible to reduce the porosity, change the structure and slow down oxidation of the ingredients incorporated within the gel.

In a preferred embodiment, an emulsifier such as for example Tween, or a phospholipid compound or a mixture of phospholipids, such as lecithin, phosphatidylcholine, phosphatidylethanolamine or mixtures thereof, is homogenized with oil prior to its incorporation within the hydrocolloid solution in order to stabilize the oil emulsion before gelation.

In various embodiments of the invention, a food additive may be for example a high calorie food ingredient or a low calorie food ingredient. In one embodiment, the high calorie food ingredient is for example an oil, fat or alcohol. In another embodiment, the low calorie food ingredient is for example non digestible polysaccharides such as agar or locust bean gum. In yet another embodiment, said food additive which is incorporated within the expanded gel comprises at least one vitamin, such as vitamin D, vitamin E or vitamin A.

In another preferred embodiment, the expanded gel comprises a vitamin, such as Vitamin A, E or D. Vitamin E may serve as an anti-oxidant. In yet another preferred embodiment, the vitamin E is added in combination with another drug in order to prevent the oxidation of said drug. Thus, the cellular solid matrices of the invention may be used as a slow release carrier for pharmaceutical drugs, preferably lipophilic drugs.

Lipophilic drugs according to the invention may be selected from the following categories: hormones, anti-inflammatory agents, anti-microbials, anti-fungals, analgesics, hypnotics, sedatives, anxiolytics, antidepressants, anticonvulsants, anti-inflammatory drugs, prostanoids, prostanoid agonists, prostanoid antagonists and vitamins.

In yet another preferred embodiment, the biological material incorporated within the gel comprises an enzyme and a biological substrate for the enzyme. In one embodiment, the enzyme is incorporated within the hydrocolloid gel prior to its expansion and the biological substrate is diffused through the gel in a later stage to start the reaction. In another embodiment, the biological substrate is incorporated within the hydrocolloid gel prior to its expansion and the enzyme is diffused through the gel in a later stage to start the reaction. In cases in which the enzyme is diffused through the gel, the diffusion of the enzyme through the gel depends on its molecular weight. High molecular weight enzymes diffuse only through the surface of gel moiety, thereby changing the porosity in the gel surface only in the gel surface. In yet another embodiment, a mixture of the enzyme with the substrate is incorporated within the hydrocolloid solution and the reaction starts immediately even before gelification. In one embodiment, said enzyme is a lipase or an industrial blend of pectolytic enzymes and the biological substrate is oil, fat or pectin.

In yet another preferred embodiment, the microorganisms which may be incorporated within the expanded gel are selected from bacteria, fungi or yeast.

Some embodiments of the present invention are produced for use as a moisture absorbent, such as for example in the diaper and hygienic pad industries. The cellular solid matrices can be compressed to a smaller volume, while maintaining their absorbing capacity, and return to a larger volume only upon absorbing liquids or during a decompression process. One major advantage of these cellular solid matrices is their biodegradability, which is complete after a few months, generally about six months after placing in the ground, thereby eliminating the problem posed by the currently used plastic or synthetic materials. In another embodiment, the cellular solid matrices of the invention may be used as a biodegradable packaging material.

These and further embodiments will be apparent from the detailed description and examples that follow.

### BRIEF DESCRIPTION OF THE DRAWINGS

FIGS. 1 and 1A are graphs showing the stress-strain relationship of the “yeast” cellular solid matrices after 3-days immersion in sucrose solution.

FIG. 2 is a representation of the structure of cellular solid matrices having yeast cells distributed in and on the cell walls.

FIG. 3 is an enlarged detail of part of FIG. 2.

FIG. 4 shows the appearance of a CO₂-filled alginate gel. On the left is a gel with carbonate before acid diffusion, and on the right an alginate gel after acid diffusion. Note bubbles bulging from its outer surface.

FIG. 5 shows stress-strain relationships of alginate gels before and after acid diffusion.

FIG. 6 shows stress-strain relationships of untreated alginate gel, and of alginate gels with 2.5% added carbonate, before and after 1 and 2% citric acid diffusion.

FIG. 7 is the typical appearance of freeze-dried gel specimens.

FIG. 8 is the cellular structure of a 1% alginate cellular solid.

FIGS. 9A and 9B show typical stress-strain relationships of the alginate cellular solid matrices resulting from gels without treatment and after 1.8 h immersion in citric acid solution. The solid lines are the fits of equation #3.

FIGS. 10 and 10A show stress-strain relationships of oil cellular solid matrices from untreated gels. Initial oil concentrations (0-40%) are as mentioned on the figure. The solid lines are the fit of equation #3.

FIG. 11 shows stress-strain relationships of oil cellular solid matrices from heat-treated gels.

FIG. 12 shows agar cellular solid matrices structure. No oil included.

FIG. 13 shows agar cellular solid matrices with 10% oil (compare with FIG. 12 to note the differences).

FIG. 14 shows agar cellular solid matrices with 30% oil (compare with FIGS. 12 and 13: to note how the structure changes and the pores begin to close up ending in closed cells).

FIG. 15 shows agar cellular solid matrices with 40% oil (compare with FIGS. 12 to 14: to note how the total structure of the sponge has changed, becoming smoother).

FIG. 16 presents a SEM micrograph of an agar-oil cellular solid. The oil is presented as mini-drops embedded within the solid wall of the matrix.

### DESCRIPTION OF THE PREFERRED EMBODIMENTS

The present invention provides biodegradable cellular solid matrices having predetermined characteristics of moisture absorption, biodegradability, pore size, pore distribution, pore density and structure. Said cellular solid matrices characteristics are determined by manipulating various parameters during production, such as for example the type and concentration of the hydrocolloid gum, type and source of gas incorporated within the hydrocolloid gel, method of drying the expanded gel, type and concentration of oil (or fat) incorporated within the hydrocolloid gel, method of removal of the oil from the gel to form spaces within the gel, or other additives incorporated within the gel.

In another embodiment, the present invention is related to the method for the production of cellular solid matrices comprising the following steps: expanding a hydrocolloid gel with a gas, wherein said gas becomes entrapped as bubbles within the matrix of said gel, and wherein said gel keeps its integrity; and drying said expanded gel.

As described hereinabove, the gas used in the invention in order to expand the hydrocolloid gel may be generated by different methods. In one embodiment, a gas is released into a sealed chamber containing the gel, said gas being compressed into said chamber, said chamber being opened abruptly causing said gas to be dissolved and entrapped within the hydrocolloid gel solution, to produce the expanded gel. In one embodiment, said gas is carbon dioxide, oxygen, nitrogen or air. In a preferred embodiment, at a temperature above the gel's setting point and during the transition from high pressure to low pressure, gas bubbles which are present in the gel prior to the compression of gas are expanded.

In another embodiment, air (or inert gases such as nitrogen, carbon dioxide, helium, argon or other noble gases) may be incorporated by bubbling the gas into the viscous gum solution before gelification using an air sparger.

In various embodiments of the invention, gas bubbles are distributed in the gel solution before gelation. In the case of agar in which the melting process is performed at high temperatures, the gel solution should be cooled in order to entrap the bubbles within the gel. When alginate is used, no cooling is required as the gelation process is performed at room temperature.

Before expanding the hydrocolloid gel, other ingredients may be added, such as a plasticizer (for example glycerol), starch, oil, sugar substitutes (up to 1%), salts (up to about 1%), colors at their respectively accepted levels, taste enhancers up to 1000 ppm and flavoring.

In another embodiment of the present invention, cellular solid matrices are produced by preparing hydrocolloid gels which contained a carbonate, and allowing acid to diffuse into them resulting in gels that contained internally produced carbon-dioxide gas bubbles. In another embodiment, the hydrocolloid gels contain the acid and the carbonate is diffused through the gel. In yet another embodiment, the acid and the carbonate are co-diffused through the gel. In one embodiment, said carbonate salt is calcium carbonate and said acid is citric acid. In a preferred embodiment, gas filled gels are produced by incorporating calcium carbonate (up to about 3%) and putting the gels in an acid solution, such as citric acid (up to about 2.5%). After a short period of diffusion, gas is produced and trapped within the gel matrix. The volume of the citric acid solution is about 100 times the volume of a single gel specimen to allow gel immersion from all sides and to ensure that the acid concentration will not be changed significantly during the operation.

In a preferred embodiment, the above expanded gel is frozen and dried and a sponge-like product is obtained. Different gels may be manufactured by changing the production order. According to one embodiment, hydrocolloid gels (including plasticizer and other ingredients) are produced. Later acid is incorporated by diffusion and gels are put inside a carbonate salt source. Carbonates diffusing into the gel are decomposed by the acid, producing a gas-filled gel.

In another embodiment, cellular solid matrices are produced by entrapping microorganisms within the hydrocolloid gels, said microorganisms being capable of producing a gas by fermentation or denitrification of a suitable substrate. In one embodiment, said microorganisms are yeast or bacteria, and said substrate is sucrose, glucose, fructose or a polysaccharide.

In a preferred embodiment, gels are placed in a suitable substrate solution such as sucrose, glucose, fructose or in a solution of an ingredient with such molecular weight that permits its diffusion through the gel. The substrate diffuses into the gels, and gas bubbles, such as carbon dioxide bubbles are formed by the microorganisms and trapped within the gel matrix. According to various embodiments of the invention, gas bubble content is determined by yeast and sugar type and concentration, temperature of diffusion, gel dimension, etc. Different gel textures may be achieved by changing the percentage of yeast, 10³ to 10⁹ cells per gram, changing sugar type and content (0.2-30%), changing the temperature or the fermentation rate and the addition of other nutrients within the system.

In yet another embodiment, the hydrocolloid gel is changing its texture by incorporation of oil within the hydrocolloid gel prior to its expansion at a temperature above the gel setting point, followed by gelification, slow heating process and drying. The slow heating of the gel is performed at temperatures below the melting point of the gel. The sponge structure is formed due to the removal of the oil from the gel during the heating. The properties of the cellular solid matrices may be changed in different concentrations of oil incorporated within the gel before heat treatment and oil extraction. In a preferred embodiment, the initial concentration of oil is up to 40% of the initial hydrocolloid gel solution and the gel is immersed in 85° C. solution for ˜15 min in order to remove the oil from the gel into the warm water in which it is immersed. The residual oil left after the heating is as stated in table 6 and the moisture content is 3% after drying.

The mechanical properties of the gels can be tested by various methods known in the art. In one embodiment, gels tested for mechanical properties are freeze-dried and maintained in the presence of desiccants, such as silica gel, to avoid rehydration prior to testing, so that their mechanical properties can be studied. The resultant cellular solid matrices are compressed to 80% deformation between parallel lubricated plates and the stress-strain relationships can be fitted to a compressibility model previously developed for the sigmoid stress-strain relationships of cellular solids: σ=C₁ε/[(1+C₂ ε) (C₃−ε)], wherein σ and ε are the engineering stress and strain, respectively, and C₁, C₂ and C₃ are constants.

In various embodiments of the invention, gels comprising one hydrocolloid such as agar, carrageenan, gelatin, alginate, pectin, gellan, konjak mannan, gels comprising two hydrocolloids such as xanthan gum plus locust bean gum, and gels comprising three or more gelling agents are used. Hydrocolloid concentrations may be up to about 5% (except in the case of gelatin which can be used in concentrations of up to about 20%).

In a preferred embodiment, agar is dissolved in water in order to obtain gelation. In another preferred embodiments, carrageenan and gellan are dissolved in hot (70-100° C.) cross-linking reaction solution in order to obtain melting followed by cooling and gelation.

The method of the present invention optionally comprises freezing the expanded gel prior to its drying in order to preserve the porosity of the gel. Drying the gel without freezing will form more condensed cellular solids. The gas-filled gels can be frozen by several techniques, such as for example freezing below or at −18° C., blast freezing, fluidized bed freezing and liquid nitrogen freezing and then dried by techniques such as by lyophilization, drying in a vacuum, drying by fluidized bed method regular drying (at 100° C. and higher) or even by sun drying when a low volume product is desired.

In a preferred embodiment, various enzymes such as for example an industrial blend of pectolytic enzymes may be diffused into the gel filled with pectin, to form pectin fragments which can diffuse out to the solution. Upon drying, a sponge-like material had been produced. A pectolytic enzyme may be for example pectin esterase (PE), pectin polygalacturonase (PG) or pectinmethylesterase (PME).

In one embodiment, the enzyme (such as a pectolytic enzyme or lipase) is incorporated within the hydrocolloid gel prior to its expansion and the biological substrate (such as pectin, oil or fat) is dispersed through the gel at a later stage to start the reaction. In another embodiment, the biological substrate is incorporated within the hydrocolloid gel prior to its expansion and the enzyme diffused into the gel at a later stage to start the reaction. In this case the enzyme decomposes its substrate on the surface of the gel.

In yet another embodiment, a sponge-like structure is produced by partial dissolution of the gel. In a preferred embodiment, agarose, optionally combined with other gelling agent is embedded in a solution of sodium iodide in conditions which permit partial dissolution of the gel. In more preferred embodiment, the partial dissolution of the agarose gel is carried out using 6M NaI at 55° C. for few minutes, preferably 1 minute. The partial dissolution enables creating pores within the matrix, that after drying will evolve in achieving the requested cellular solid.

In one embodiment, the method of the invention further comprises incorporating within the gel hydrophilic or hydrophobic additives, such as for example a flavor, a coloring material (such as β-carotene), a plasticizer (such as glycerol), a salt (such as potassium chloride or calcium chloride), a preservative (such as sodium bisulfite, potassium sorbate, sodium benzoate, sodium iodide, thimerosal, chlorbutanol, or methyl, ethyl, propyl or butyl parabens), an acidifying agent (such as calcium hydrogen phosphate or citric acid), a water soluble polymer (starch, pectin), a sweetener (such as saccharin), a sequestering agent or chelator (such as ethylene diamine tetraacetic acid (EDTA) or sodium hexa metaphosphate (SHMP)), an emulsifier (such as Tween, or phospholipids), a filler (such as starch), a food additive (such as vitamin D), a high calorie food ingredient (such as oil or fat), a low calorie food ingredient (such as a polymer or other gum), a biological material (such as bacteria or fungi), microorganisms (such as bacteria, fungi or yeast), a drug (such as vitamins, hormones or pharmaceutical drugs) or a combination thereof. Most ingredients are added to the setting solution, in a few cases aroma and color ingredients are sprayed on the dried surface.

Lipophilic drugs according to the invention may be selected from the following categories: hormones, anti-inflammatory agents, anti-microbials, anti-fungals, analgesics, hypnotics, sedatives, anxiolytics, antidepressants, anticonvulsants, anti-inflammatory drugs, prostanoids, prostanoid agonists, prostanoid antagonists and vitamins.

In a preferred embodiment, an emulsifier is added to the hydrocolloid gel in order to stabilize the oil emulsion before gelation. For example, SHMP is added to trap cations in order to prevent premature gelification in cold set alginates. Preferred emulsifiers include for example sodium hexa metaphosphate (SHMP), synthetic emulsifier such as Tween, Triton or Euphoric, a phospholipid compound or a mixture of phospholipids. Suitable components include lecithin; MONTANOL-68, EPICURON 120 (Lucas Meyer, Germany) which is a mixture of about 70% of phosphatidylcholine, 12% phosphatidylethanolamine and about 15% other phospholipids; OVOTHIN 160 (Lucas Meyer, Germany) which is a mixture comprising about 60% phosphatidylcholine, 18% phosphatidylethanolamine and 12% other phospholipids; a purified phospholipid mixture; LIPOID E-75 or LIPOID E-80 (Lipoid, Germany) which is a phospholipid mixture comprising about 80% phosphatidylcholine, 8% phosphatidylethanolamine, 3.6% non-polar lipids and about 2% sphingomyelin. Purified egg yolk phospholipids, soybean oil phospholipids or other purified phospholipid mixtures are useful as this component. This listing is representative and not limiting, as other phospholipid materials which are known to those skilled in the art can be used.

In various embodiments of the invention, a food additive may be for example a high calorie food ingredient or a low calorie food ingredient. In a preferred embodiment, such food additive which is incorporated within the expanded gel comprises at least one vitamin, such as for example vitamin A.

In another embodiment, the cellular solid matrices of the invention are produced for use in the diaper and hygienic pad industries. The cellular solid matrices can be compressed to a smaller volume, while maintaining their absorbing capacity, and can revert to a larger volume only upon absorbing liquids or decompression. The big advantage of these cellular solid matrices is in their biodegradability. Decomposition is complete after a few months, generally about six months, when placed in ground, thereby eliminating the problem posed by the currently used plastic or synthetic materials. In yet another embodiment, the cellular solid matrices of the invention may be used as a biodegradable packaging material having predetermined mechanical characteristics.

In yet another embodiments, the cellular solid matrices of the invention may be used for a carrier for a drug, such as a pharmaceutical drug. In a preferred embodiment, a drug, such as a drug soluble in oil is incorporated within a sponge comprising oil, thereby preventing the oxidation of the drug. Thus, the cellular solid matrices of the invention may be a slow release carrier for lipophilic drugs.

Lipophilic drugs according to the invention may be for example from the following categories: hypnotics, sedatives, anxiolytics, antidepressants, anticonvulsants, anti-inflammatory drugs, anti-fungals, prostanoids, prostanoid agonists, prostanoid antagonists, analgesics, hormones and vitamins. Specific examples would include lipophilic peptides, barbiturates, benzodiazepines, phenothiazines, cyclosporin, diphenoxylate, physotigmine, tacrine, diclofenac, dexamethasone, prostaglandins, nifedipine, nitroglycerine, atropine, verapamil, fentanyl, lipophilic peptides, ketotifen, phenytoin, miconazole and ketoconazole.

In yet another preferred embodiment, the cellular solid matrices of the invention may be used as a carrier for biological materials. Such biological materials which are incorporated within the expanded gel may be for example bacteria, fungi or yeast. For example, such bacteria may be able to decompose ammonia in aquatic containers or to be used in biological systems where denitrification is required. In another embodiment, the cellular solid matrices of the invention may be used as a carrier for enzymes and substrates.

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### EXAMPLES

### Example 1

An air-filled gel was prepared as follows:

| | Concentration |
|---|---|
| Ingredient | (%, w/w) |
| Calcium hydrogen orthophosphate | 1 |
| Sodium alginate | 2 |
| Calcium carbonate | 1 |
| Glucono δ-lactone (GDL) | 1 |
| Citric acid | 2 |

Alginate powder 1% w/w, calcium hydrogen orthophosphate (CaHPO₄) 1% and 1% calcium carbonate were added slowly to stirred cold distilled water until complete dissolution of the ingredients. A freshly prepared solution of 1% glucono-delta-lactone was then admixed with this solution using vigorous stirring. The alginate solution was poured into a plastic container (10×10×8 cm) and let to set there. After 48 hours specimens were taken from the slab using a cork borer and immersed in citric acid solution 2%. The volume of the citric acid solution was about 100 times the volume of a single gel specimen to guarantee excess acid.

With the diffusion of the citric acid solution there were formed carbon dioxide bubbles, part of which were entrapped in the gel. There resulted a gel containing about 6,500 bubbles per cubic centimeter and the gel was transferred to cold storage at −20° C. and afterwards to drying while frozen, at −50° C. and at 7.6×10⁻³ torr sublimation vapor pressure (ice). There was obtained an edible sponge, devoid of any caloric value. It is possible to introduce into the acid solution a small concentration of a sweetening agent, such as 0.5% or less saccharin or food color (10 ppm tetrazine) so as to obtain as final product a sweet tasting yellow colored calorie-free edible sponge.

### Example 2

A sponge was prepared as in Example 1, but which has nutritional value. The citric acid solution used contained 12% sucrose and 25 ppm red color (Ponceau 4). After about 3 hours the gel was frozen in a blast freezer during about 2 hours, and lyophilized at −45° C. at 7.6×10⁻³ torr sublimation vapor pressure (ice). There was obtained a sponge having a density of about 0.07 g/cm³ and a caloric value of about 0.5 kcal/gram.

### Example 3

| Ingredient | % |
|---|---|
| Agar | 1 |
| Pectin | 1 |
| Water | 98 |

The agar was dispersed in water and after 10 minutes stirring, the solution was heated to 95° C. for 2 minutes and cooled down to 70° C. At this stage the pectin was slowly introduced into the solution, and after cooling there was obtained an agar-pectin gel. This was cut up into desired size and introduced into a 1,000 ppm solution of pectolytic enzymes (commercially available). This constitutes a large excess of such enzymes respective the gel. The system was warmed to 38° C. and maintained at this temperature during 5 hours. The excess of the enzyme was removed by immersion in water at 38° C. during half an hour, and this was repeated 3 times. The gel was frozen in liquid nitrogen and freeze dried. There was obtained a product of a density of from about 0.03 to about 0.1 g/cm³.

### Example 4

κ-carrageenan 1.5 (% w/w)

Konjak mannan 1.5 (% w/w)

Potassium chloride 2.0 (% w/w)

Soya oil 20 (% w/w)

Water 76 (% w/w)

The konjak mannan (a type of hydrocolloid) was dispersed and dissolved in the water which contained 2% potassium chloride. After warming to 70° C., κ-carrageenan was added and the solution was stirred until this dissolved. After cooling to 45° C., and in any case to above the setting point of the κ-carrageenan. Then soybean oil was added with vigorous stirring for achieving homogenization and the resulting suspension was cooled rapidly to room temperature. This prevents separation of the oil. The gel, containing the oil, was left under refrigeration for 24 hours and introduced into water at 35° C. under vigorous stirring. Thus part of the oil is separated, and the remaining gel was frozen and freeze dried. There was obtained a spongy edible product, density: 0.075 g/cm³, edible value: about 0.8 kcal/g.

### Example 5

Bacteria of the strain Pseudomonas stutzeri were immobilized in a chitosan-alginate gel. In addition to the gas formation by decomposition of nitrogenous materials, a polysaccharide was produced by the microorganisms, which enhances the mechanical properties of the sponge before drying and prevents its disintegration.

### Example 6

Creating cellular solid matrices by an immobilization process: Saccharomyces cerevisiae (yeast) was cultivated in Potato Dextrose Agar broth (Difco, Detroit, Mich., USA) for 2 days at 30° C. The cells were harvested by centrifugation at 3000 g for 15 min at 5° C. and washed twice with sterile deionized water. The yeasts were diluted as needed in sterile deionized water and stirred at 5° C. no more than 15 min until immobilization was performed. Yeasts were counted directly in a Neubauer chamber (West Germany). Immobilization was performed by thoroughly mixing, nine parts 2% (w/w) agar with one part diluted yeast solution to obtain gels with 10⁸ and 10⁹ immobilized yeast per ml. The microorganism suspension was added directly after bringing the cell suspension to 28° C. The gel-cell mixture was mixed for 5 min prior to pouring into stainless-steel cylindrical molds. Reference gels with no microorganisms were prepared in parallel. The gels were immersed in a 5% sugar solution, to induce fermentation. The volume of the sucrose solution was 30 times that of the immersed gels. The mechanical properties of gels with entrapped carbon-dioxide bubbles were studied after 3 and 7 days. Parallel gels were freeze-dried and checked for their sponge properties and structure.

The influence of yeast immobilization on the mechanical properties of an agar gel at time zero, 3 days and 7 days is presented in Table 1. It was found that the higher the concentration of the microorganisms within the gel, the higher the disturbance to its integrity. In other words, stresses at failure and deformability moduli decreased by the immobilization of the yeasts. The brittleness of the gels also increased (their strain at failure decreased). Similar results have been achieved previously for bacteria, yeast and spore immobilization (Nussinovitch et al., 1994). After yeast immobilization, the gels were immersed in an excess volume of 5% sucrose solution (the sucrose content in the gels reached the 5% level after 5 h at 30° C.). Slow fermentation occurred, perhaps because no nitrogen source was added. It is also possible that the lag time for yeast growth was longer causing immobilized yeast to react later than their non-entrapped counter parts. As a result of the fermentation, carbon-dioxide bubbles and ethanol were produced and a decline in pH was observed. The gas bubbles moved from their site of production (throughout the inside of the gel) to the surface of the gel, causing some mini-cracks in the gel and later influencing the structure of the resultant sponge.

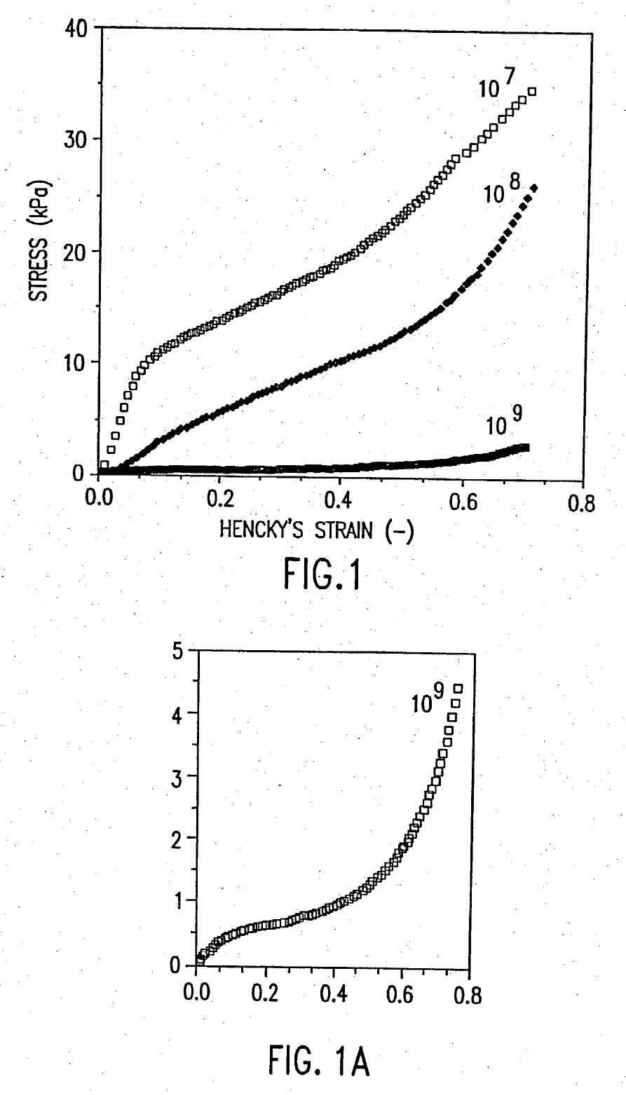

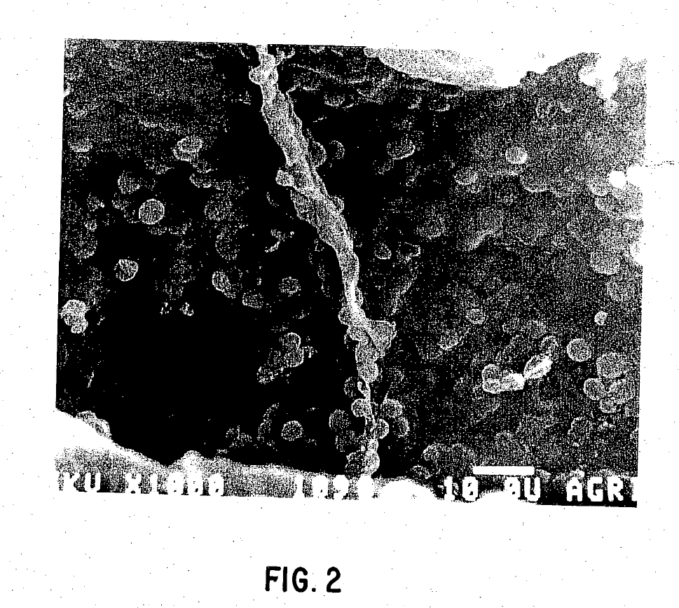

The longer the fermentation, the less strong and stiff the gels (Table 1). The shape of the stress-strain relationship of the “yeast” sponge after 3 days immersion in sucrose solution is shown in FIG. 1 and FIG. 1A. All cellular solid matrices showed the sigmoid curve characteristic of cellular solids, which is a manifestation of the three deformation mechanisms mentioned hereinbelow. The constants in equation 3 for the description of the stress-strain relationship, achieved by nonlinear regression, are presented in Table 2. The major difference between cellular solid matrices was in the magnitude of C₁. The higher the concentration of the entrapped microorganisms, the smaller the value of this constant, which reflects shoulder shape and prominence in the stress-strain curves. Small mean square error (MSE) values indicated a good fit. The structure of these cellular solid matrices is presented in FIG. 2. The yeast cells seem to be distributed in and on the cell walls of the sponge and to be attached to its outer surfaces. As previously mentioned, the compression of all cellular solid matrices produced after 3 days of gel immersion in sucrose solution resulted in stress-strain relationships similar to those of a regular sponge. This was true for all yeast concentrations used in this study. However, after 7 days immersion in the sucrose solution, a different phenomenon was observed.

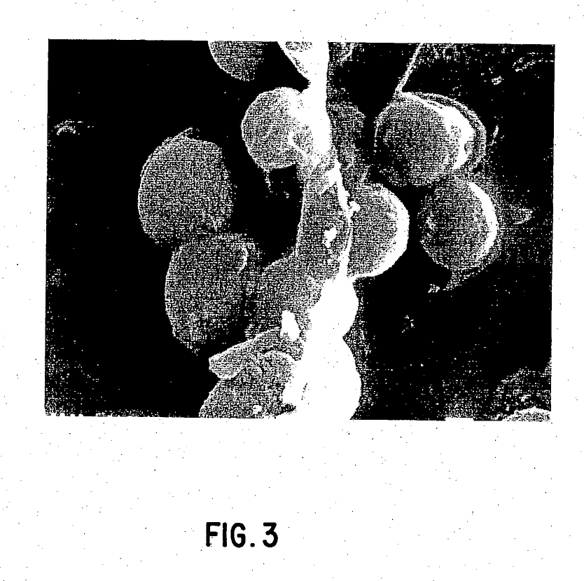

For 10⁷ yeast/g gel a “regular” stress-strain relationship was still observed, whereas when higher initial yeast concentrations such as 10⁸ and 10⁹ yeast/g gel were used, the yielded manufactured products did not resemble cellular solid matrices in their stress-strain behavior. This can be partially explained by noting that an increase in the time of fermentation results in an increase in biomass (a fivefold increase in the protein content of gels before freeze-dehydration performed was observed). From FIG. 3 depicting a magnified portion of FIG. 2, it can be concluded that in compressed cellular solid matrices with initially high yeast concentrations after 7 days immersion in sucrose solution, compaction of a “yeast-hydrocolloid” rather than a hydrocolloid network occurs, resulting in different products and properties. Comparing cellular solid matrices prepared from gels without yeast to those prepared from gels with 10⁹ entrapped yeast/g (after 3 days gel immersion in a 5% sucrose solution) is performed, a decrease in porosity from 96% to 92% was observed. This may be due to the increased dry matter content of the sponge.

### Example 7

A 2% solution of gellan was prepared, and 0.2% calcium chloride (or 2% agar without such additive) or 2% κ-carrageenan with 1% of potassium chloride, or of 1% xanthan and 1% locust bean gum). The gellan solution was prepared by gradually adding gellan powder to an aqueous solution of the calcium chloride at about 90° C. The solution of gellan was cooled to about 40° C. or less, so as to bring about gelification. At this stage there was added to one liter of the solution a suspension of 10⁹/ml of baking yeast of the saccharomyces type, and the solution is cooled rapidly to obtain gelification. In order to avoid a drastic reduction of the active yeast cells one has to work with a hydrocolloid which sets at room temperature. The obtained gels were cut into circular disks of about 20 mm diameter and 20 mm height, and inserted into a 10% sucrose solution. The sucrose diffuses into the gel and the yeast ferments the sugar resulting in carbon dioxide bubbles which are entrapped in the gel (about 10,000 bubbles per cubic centimeter). The gel containing the carbon dioxide, which contains also residual sugar and ethanol produced during the fermentation, is frozen and dried, resulting in an edible sponge of unique structure. It is possible to carry out such processes with beads of the gel and thus obtain spongeous products for use in biotechnology.

### Example 8

Expanded gels produced according to this example were prepared using a solution of 2% gelling agent into which there was introduced a gas such as oxygen, carbon dioxide, nitrogen or air using an air sparger. The viscosity of the medium preserves the gas bubbles in the gel. Thus, after gelification, a large quantity of these bubbles are included in the gel.) The expanded gel is subjected to freeze drying, as in preceding Examples.

### Example 9

Gels produced according to Example 5 or 6 are expanded using a gas which is released into a sealed chamber containing the gel. The chamber can previously be filled with fluid or only contain air. A gas is compressed into said chamber, said chamber being opened abruptly causing said gas to be dissolved and entrapped within the hydrocolloid gel, resulting in incorporation of air bubbles. After freezing and drying a sponge is obtained.

### Example 10

The mechanical properties of gels were determined as following: Gels were compressed to failure between parallel lubricated plates at a constant deformation (displacement) rate of 10 mm/min, corresponding to an initial 0.011 s⁻¹ strain rate using an Instron Universal Testing Machine model 1100. The Instron was connected to an IBM-compatible personal computer by an analog to digital conversion interface card. A program developed at the Instron Corporation (Canton, Mass.) and modified in our laboratory, performed the data acquisition and conversion of the Instron's continuous voltage vs. time output into digitized force-deformation, force-time, stress-strain, or stress-time relationships with any desired definition of stress and strain. All mechanical tests were performed in triplicate, with samples taken from two separate batches.

The different cellular solids, those with internally produced gas bubbles, those produced by fermentation and those including oil within the gum mixture, were freeze-dried to create the cellular solid structures. They were compressed to 80% deformation between parallel lubricated plates at a constant deformation (displacement) rate of 10 mm/min, using the Instron. The Instron's continuous voltage vs. time output was converted into stress vs. Hencky's (natural) strain relationships:

σ=F/A₀ (1)

and

ε_{H}=ln[Ho/(Ho−ΔH)] (2)

where σ and ε are stress and Hencky's strain, respectively, F is the momentary force, ΔH=Ho−H(t) is the momentary deformation, Ao and Ho are the original specimen's cross-sectional area and height, respectively, and H(t) is the height at time t. Since the cross-sectional area of a compressed solid sponge specimen rarely expands to any significant extent (Gibson and Ashby, 1988), the engineering and “true” stresses could be treated as equal for all practical purposes (Swyngedau et al., 1991a).

The individual relationships were fitted to a compressibility model previously developed for the sigmoid stress-strain relationships of cellular solid matrices (Swyngedau et al., 1991a; Nussinovitch et al., 1989; Swyngedau et al., 1991b):

σ=C₁ε/[(1+C₂ε)(C₃−ε)] (3)

where σ and ε are the stress and strain, respectively, and C₁, C₂ and C₃ are constants calculated by nonlinear regression of the Systat package. The constant C₁ is primarily a scale factor and has stress units. The constant C₂, dimensionless, is a measure of the shoulder's prominence in the stress-strain curve-that is, when C₂═O, the relationship has no shoulder and its slope increases monotonically. The constant C₃, also dimensionless, is a rough measure of the steepness of the stress-strain curve in the high-strain region. According to equation 3, when ε goes to C₃ σ tends to infinity. C₃ is determined largely by the strain level at which collapse of the open structure has been completed and most of the resistance to deformation has been shifted to the compacted solid cell wall material. All mechanical tests were performed in duplicate.

Porosity was defined as the volume fraction not occupied by particles or solid material and could therefore be expressed as: Total porosity=1−(bulk density/solid density) (Peleg and Bagley, 1982).

Into an agar solution there was introduced a quantity of about 20% w/w of an oil, all other constituents being as in the preceding example and this was processed as before. The product has a reduced porosity of about 80%. This demonstrates another option for the control of the porosity of the product. The wall of the cells formed are more rounded and the sponge is less breakable. The results of the mechanical properties of the gels is detailed in Table 1 and Table 2 below.

TABLE 1
Influence of time of sucrose fermentation with different
concentrations of entrapped Saccharomyces cerevisiae
on the mechanical properties of 2% agar gels

| | | | |
|---|---|---|---|
| Yeast Concentration | Stress at failure | | |
| (CFU/g) | (kPa) | Strain at failure (−) | E_{D} (kPa) |

A. Fermentation time at 30° C. - 0 days

| | | | |
|---|---|---|---|
| 0 | 39.5 ± 1.1 | 0.26 ± 0.01 | 136.7 ± 4.1 |
| 10⁸ | 28.9 ± 1.2 | 0.25 ± 0.02 | 134.9 ± 2.8 |
| 10⁹ | 22.2 ± 1.4 | 0.21 ± 0.01 | 129.7 ± 2.2 |

B. Fermentation time at 30° C. - 3 days

| | | | |
|---|---|---|---|
| 0 | 24.8 ± 1.2 | 0.23 ± 0.01 | 122.2 ± 2.2 |
| 10⁸ | 22.7 ± 0.8 | 0.23 ± 0.00 | 111.4 ± 1.8 |
| 10⁹ | 11.5 ± 0.5 | 0.19 ± 0.01 | 59.9 ± 1.0 |

C. Fermentation time at 30° C. - 7 days

| | | | |
|---|---|---|---|
| 0 | 22.4 ± 1.0 | 0.22 ± 0.01 | 119.2 ± 2.4 |
| 10⁸ | 20.4 ± 0.8 | 0.21 ± 0.01 | 101.8 ± 2.0 |
| 10⁹ | 9.4 ± 0.6 | 0.17 ± 0.01 | 44.4 ± 0.6 |

Each result is the average of at least six determination±standard deviation (SD) taken from two separate gel batches.

TABLE 2
Model Constants Of Nonlinear Regression In Compression
Stress-Strain Relationships Of Yeast-Gels After
3 Days Of Fermentation In Freeze-Dried
Cellular Solid Matrices

| CFU/g) | C₁ (MPa × 10⁻²) | C₂ (−) | C₃ (−) | MSE^{a} (× 10⁻⁷) |
|---|---|---|---|---|
| 10⁷ | 31.7 | 19.1 | 1.13 | 2.16 |
| 10⁸ | 4.4 | 4.7 | 0.98 | 0.74 |
| 10⁹ | 0.4 | 7.8 | 0.96 | 0.02 |

^{a}MSE mean square error; CFU-colony forming units; MPa-Mega Pasqal.

### Example 11

Alginate gels were produced as above, except that soy oil was added by homogenization (APV Rannie, model mini lab type 8.30H) up to 40% (w/w) into the gum solution to which a 2% (w/w) GDL solution was later added. Tween 80 (0.1%, w/w) was also included in the oil before homogenization. Gels were kept at 5° C. for 24 h. They were then equilibrated to room temperature before heat treatment, 5 min/15 min in warm water (85° C.), to induce the oil's removal from the gels into the warm water in which they were immersed. The volume of the warm water was about 20 times of the gels. The water was replaced three times, and the alginate gels were therefore kept immersed for about 45 min, before they were compressed as gels or freeze-dried compressed as cellular solids, as described further on.

### Example 12

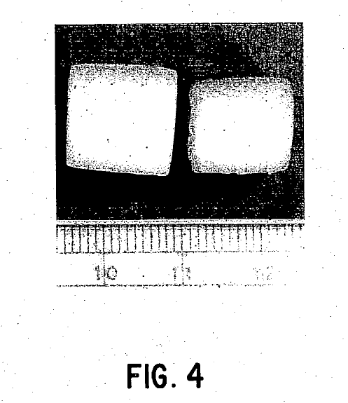

FIG. 4 shows a CO₂-filled alginate gel, before (left) and after (right) completion of the process, i.e. before and after the acid had diffused to the center of the gel. Gas bubbles seem to be trapped within the gel body and to bulge from its outer surface. The motion of the acid within the gel was by controlled diffusion, as evidenced from the linearity of the penetrated distance vs. t^{1/2}. As previously mentioned, the gels used in these experiments contained phenolphthalein in them so that the distance could be measured directly with a caliper after the specimen was dissected. The slope of the distance vs. t^{1/2} slope was about 0.7 mm×min^{-0.5}.

Inside the alginate gels, small gas bubbles were created. After 2.5 h, about 900 “bubbles/cm³ were counted. This number increased to about 2000-2700 after 24 or 36 h, depending on the carbonate concentration. Bubble formation decreased the density of the gels, causing them to float. After a while bubbles began traveling out of the gel, causing some damage to its integrity, and allowing liquid to gradually fill the empty space. Consequently, the gels began to sink again.

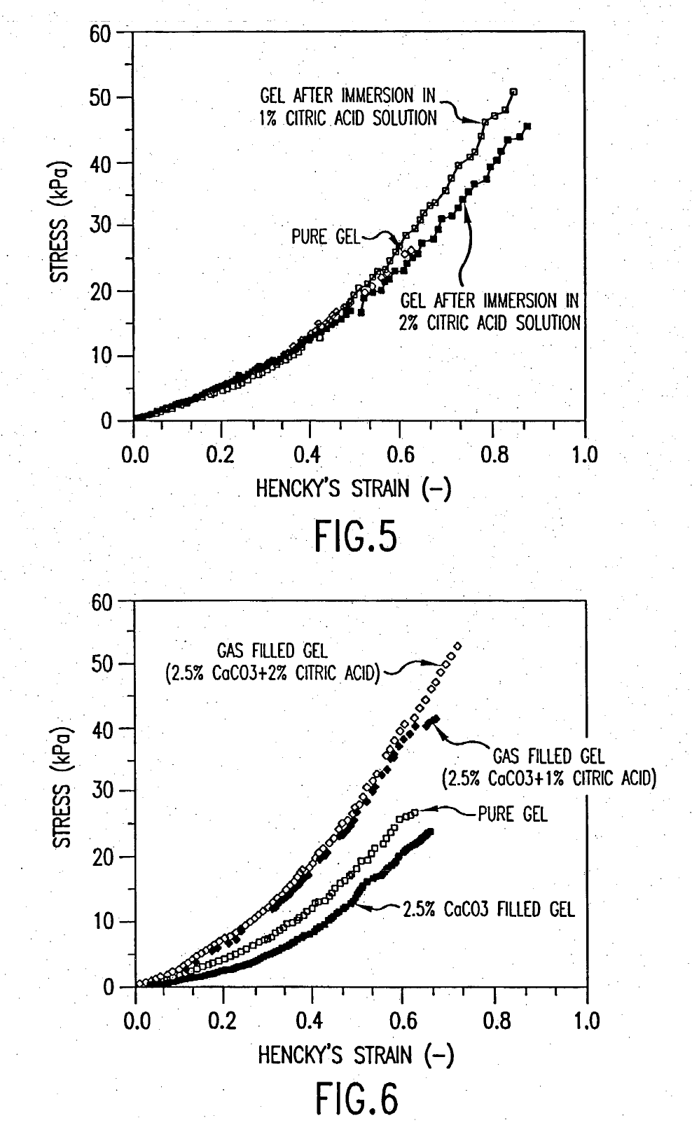

Typical stress-strain relationships of ordinary and gas-filled alginate gels are shown in FIGS. 5 and 6. Immersion in acid increased gel strength and deformability. For example, alginate gels without carbonate immersed for 2.5 h in a 0.5% citric acid solution increased their average stress at failure from 28 to 46 kPa. The Hencky's strain of these gels increased from 0.64 to 0.83, indicating that the gels become less brittle. The increase in failure stress and strain was found for all tested alginate systems, immersed in 0.5-2.0% citric acid solutions. This may be due to acid-induced cross-linking, which helped the gel retain its mechanical strength, even in the face of the structural disruption caused by bubble formation. The presence of carbonate, however, had a disruptive effect, primarily manifested in lower stiffness. Thus gel strength depended on both acid and calcium carbonate concentrations.

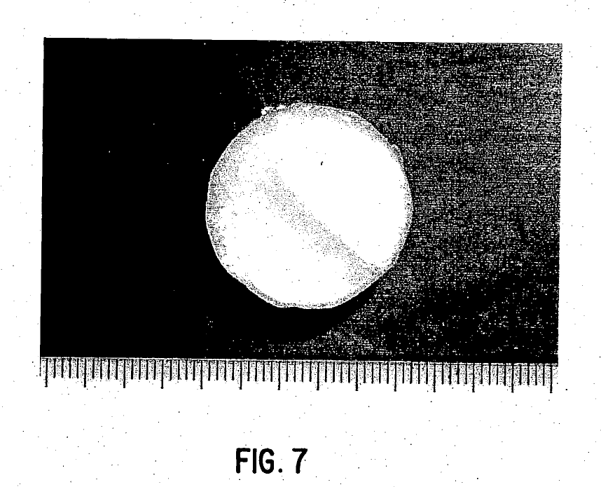

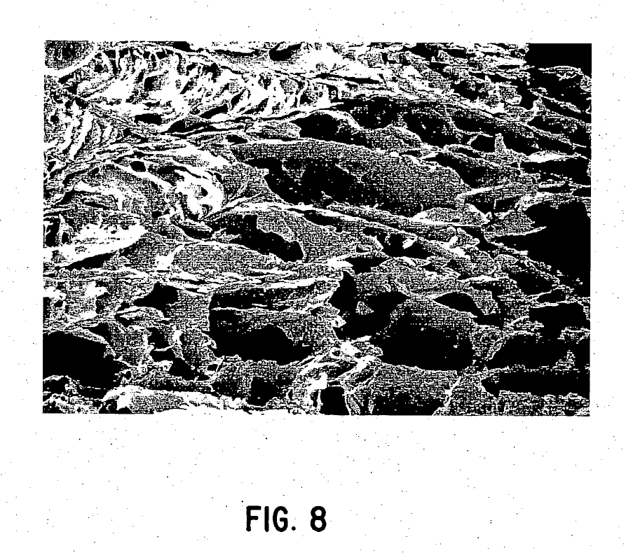

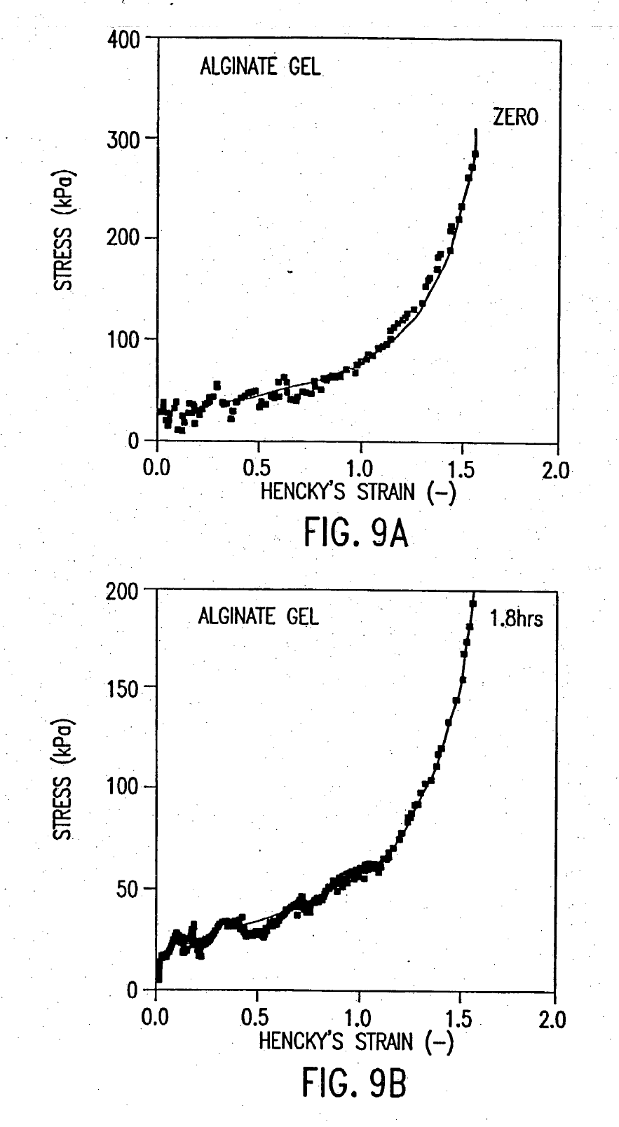

Freeze-dried gel specimens are shown in FIG. 7 and their cellular structure in FIG. 8. Since the shape of the dried specimen (final product), approximates that of the gels before dehydration, products can be designed in any shape or size, by building the desired molds. The structure of the cellular solid is determined by the freeze-dehydration process as well as by changes in the gel's processing and components. Typical stress-strain relationships of the dry cellular solid matrices are shown in FIGS. 9A and 9B. They all showed the sigmoid shape characteristic of cellular solids, which is a manifestation of three deformation mechanisms. The first part of the curve, i.e., the almost instant rise of the stress, represents the deformation of the intact sponge. Since all the tested specimens were brittle, failure occurred after a very small, hardly measurable strain. The moderate slope of the curve represents progressive rupture and collapse of the cell walls and densification of the compressed specimen. This was followed by compression of the compacted cell wall solid material, which is manifested in the rapid rise of the slope of the stress-strain curve. The stress-strain curves of the alginate cellular solids, especially in the second region, were irregular. Such irregular relationships are quite common in brittle solid foams (Attenburrow et al., 1989). The fit of equation 3, which was originally developed for spongy baked goods and polymeric cellular solid matrices and is shown as a solid line in FIGS. 9 and 9A. indicates that the compressibility model suits the type of sponge created here. The regression parameters of equation 3 are summarized in Table 3. The magnitude of the mean square error for the alginate cellular solid matrices is a reflection of the inherent ruggedness of the stress-strain relationships rather than a reflection of the fit of equation 3 as a model. With the alginate cellular solids, immersing of the gels in an acid bath did not result in a drastic loss of mechanical integrity. This appears to be because the disruptive effects of the bubble formation were at least somewhat offset by the more extensive cross-linking. The constants C₁, C₂ and C₃, as previously mentioned, were determined by a nonlinear regression procedure that is based on minimizing the mean of the squared deviations.

### Example 13

Oil was included in the cellular solid matrices to change properties such as structure, density, porosity, etc. The properties of the oil, as provided by its local manufacturer, are presented in Table 4. The mechanical properties of alginate-oil gels are shown in Table 5. The higher the content of the oil within the gel, the lower its stress at failure, and stiffness as reflected by the deformability modulus. The higher the content of the oil, the smaller the Hencky's strain at failure, or in other words the gel was more brittle. Two systems of oil gels and cellular solid matrices were dealt with in this study: in the first gels with and without oil were simply freeze-dried directly; in the second, the gels were heat-treated at 85° C. for 15 min in water, three times in succession. Each time the water and the extracted oil were discarded. Oil content in the gels and cellular solid matrices was estimated by the Soxhlet method and is given in Table 6. After heat treatment, 40-50% of the oil had “left” the gel. After freeze-dehydration the oil percentage with the sponge increased.

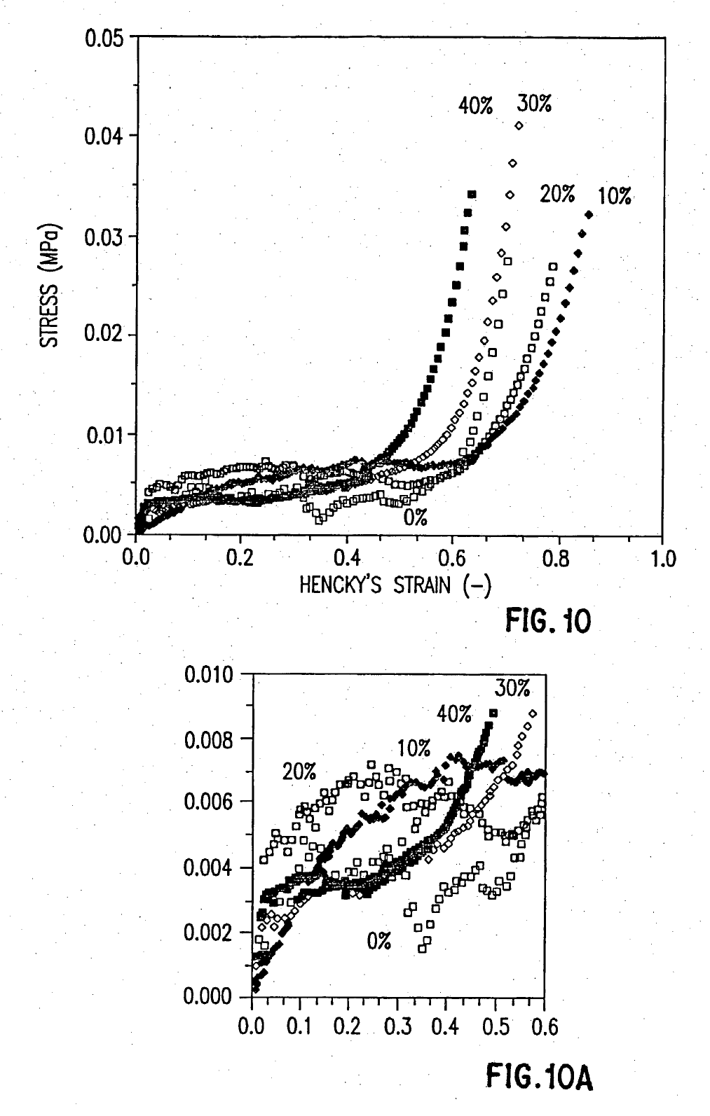

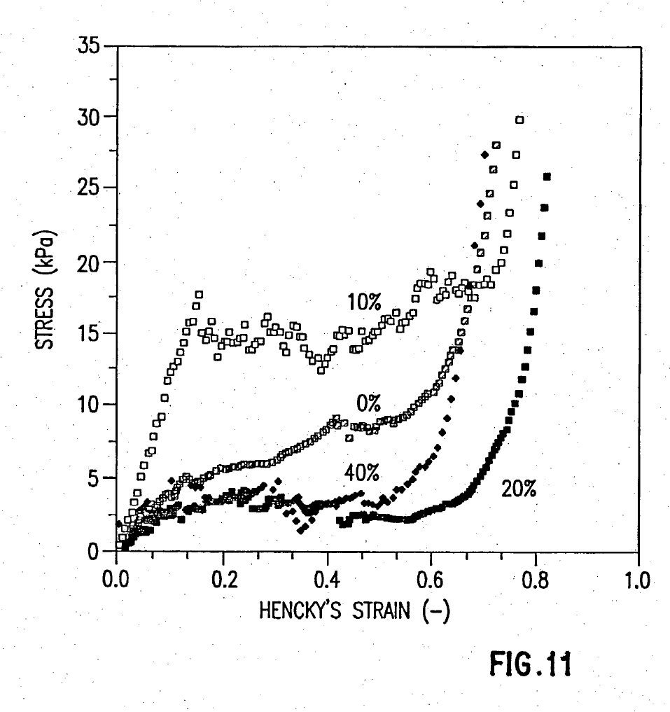

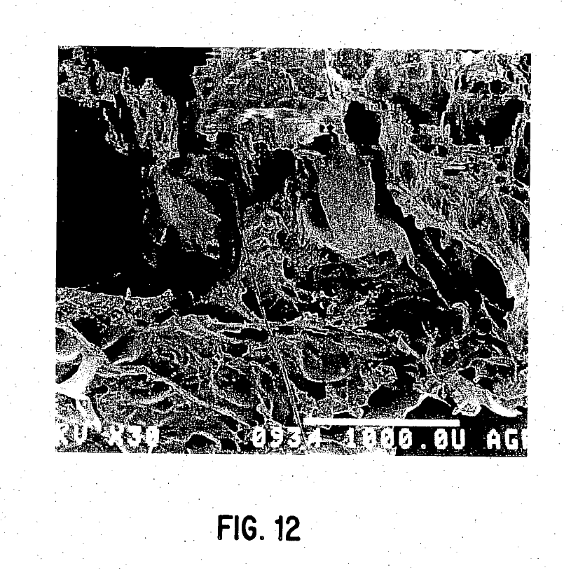

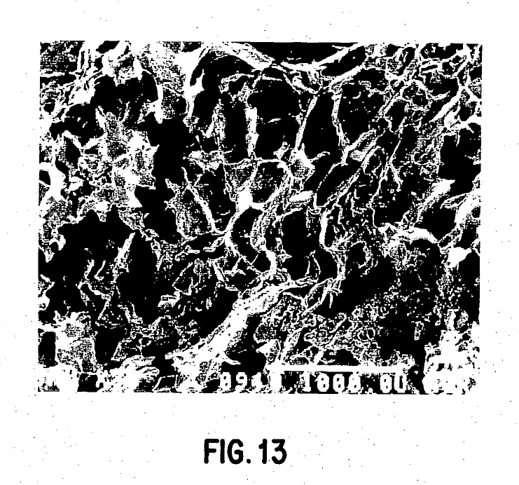

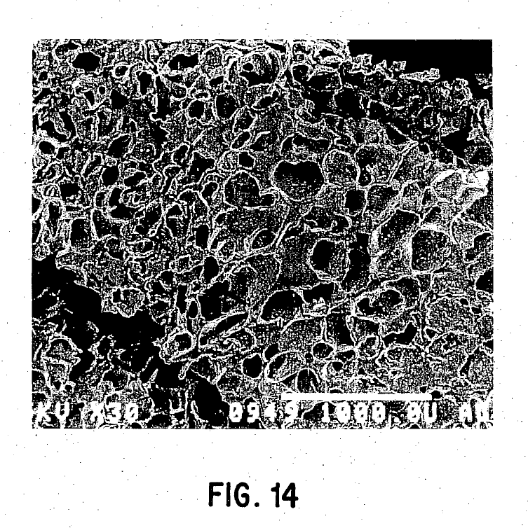

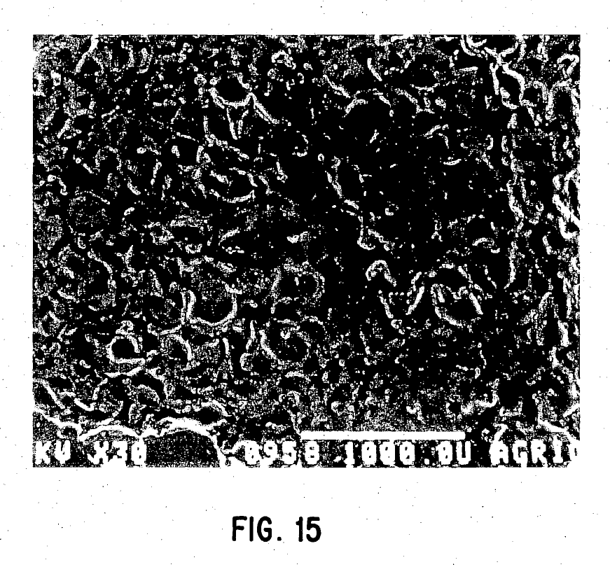

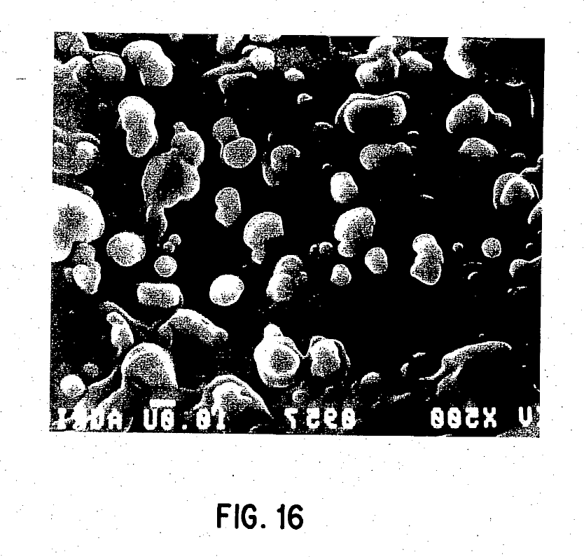

The stress-strain relationships of the oil cellular solid matrices are presented in FIGS. 10 (as is) and 11 (after heat treatment and partial oil extraction), and the results of the nonlinear regression for determining the constants of equation 3 for the curves in FIG. 9 are presented in Table 7. In FIG. 10A the ruggedness of the curves up to 40% deformation is shown. Two facts can be observed. The higher the oil content within the sponge, the smoother, the curve, in addition the C₂ constant of the nonlinear regression decreases. The higher the bulk density of the sponge (from 0.074 g/cm³ for those without oil inclusion to 0.29 g/cm³ for 40% initial oil inclusion before freeze-dehydration), the more the stress tends to steepness at smaller deformations. Heat treatment was used as one of the possible methods of oil extraction. After extraction (and see FIG. 11 and the above discussion), the stress-strain curves became more rugged. The heat treatment may disrupt the gel structure, physically damaging the specimen surface. The porosity of the cellular solid matrices changed dramatically after oil inclusion. when the oil was left the gel, porosities changed from 95% (no oil included) to 80% (40% oil included in the gel before freeze dehydration). The porosity of the other non-heat-treated system was not studied. Electron microscopy of the cellular solid matrices (FIGS. 12-15) revealed that the higher the oil content in the sponge, the more closed cells within its structure. In addition, the structure of the cells changed from big openings to rounder, smaller ones. The oil can be seen as mini-drops embedded within the solid wall of the matrix in a scanning electron microscopy (SEM) micrograph (FIG. 16).

### Example 14

Hydrocolloid cellular solid matrices are in essence dry-gel products. They were produced by preparing cold-set 1% alginate gels containing vitamin A. All gels were freeze-dried and kept over silica gel to avoid rehydration prior to testing, or were packaged in a laminate before clinical testing. Eighty children from a rural area in Northern Ethiopia were fed edible, fortified hydrocolloid cellular solid matrices carrying 4000 IU of vitamin A. The edible cellular solid matrices were being tested as a means of supplementing preschool children in an area with endemic vitamin-A deficiency. Levels of vitamin A increased significantly following ingestion of the edible cellular solid suggesting its usefulness as a carrier of vitamin A for children. The sponge consisted of hydrocolloid matrices to which oil had been added by homogenization. After gelation and freeze-drying, a crunchy, chewable, cellular solid designed as “packaging” for the vitamin A was produced. Because it is void of flavor, odor and color, these characteristics can be controlled and incorporated during processing, to ensure broad acceptance by the targeted subjects. The product was studied for its mechanical (textural) properties to enable customized, affordable, stable packaging.

Vitamin A is an essential micronutrient involved in growth, epithelial maintenance, vision and reproduction (1). Vitamin-A deficiency (VAD) is a widespread problem, affecting mainly developing countries. Worldwide, 20 to 40 million children are estimated to be at least mildly vitamin-A deficient. VAD is the major cause of blindness among preschool children in many developing countries and also carries an increased risk of morbidity and mortality. Subclinical VAD has also been associated with high child morbidity and mortality and vitamin-A supplementation has been shown to reduce these substantially (2). At present, there are three approaches to dealing with the problem of VAD: a) biannual distribution of a high-level dose of vitamin A to preschool children in area where VAD is a public-health priority; (b) horticultural and nutritional education, and (c) food fortification. However at this point, these approaches are only technologically feasible on an experimental basis in a number of countries due to their cost and the problem of selecting a suitable vehicle (a food item regularly eaten by the target group in sufficient quantities) (3). (d) One of the biggest obstacles to supplementing children with vitamin A is lack of compliance caused by taste.

In the rural area of Gondar, Ethiopia, 220 families were screened for vitamin-A status. Blood was obtained from 161 preschool children, 2-5 yrs of age. Following the first blood drawing, 80 children were randomly chosen to receive the fortified edible sponge monthly for 3 months. A field worker visited the houses of the preschool children every 2 weeks. Blood was drawn again after the 3-month period to determine vitamin-A levels. The study was approved by the ethics committee of the Gondar College of Medical Sciences. Reverse-phase high-pressure liquid chromatography (HPLC; GBC Co.), at a working pressure of 2.6 MPa, and a flow rate of 0.6 ml/min equipped with a Lichro Cart 125-4 column, filled with 10ORP-18 of Merck and flushed with 20% (v/v) ethyl acetate/methanol (7) was used to detect vitamin-A levels during sponge formation and in the sera of the preschool children receiving the sponge.

The commercial food-grade alginate Keltone LV (Kelco, San Diego, Calif.) (mol wt. 70,000-80,000, 61% mannuronic acid and 39% guluronic acid content) was used to prepare the gels, which were later freeze-dried for sponge production. The sodium-alginate powder (1%, w/w), 1% (w/w) calcium hydrogen orthophosphate (CaHPO₄; (Riedel-deHaen, Seelze, Germany) and 1% sodium-hexa-meta-phosphate (SHMP; BDH, Poole, England) were slowly added to cold (10° C.) distilled water, with constant stirring, to complete dissolution. A freshly prepared solution of 2% (w/w) glucono-δ-lactone (GDL; Sigma, St. Louis, Mo.) was vigorously stirred into solution. Alginate-vitamin A gels were produced as above except that 500 ppm vitamin A, 1% soy oil, 500 ppm lecithin, sodium saccharin and 50 ppm β-carotene were added by homogenization for 20 min at 700 bar (APV Rannie, model mini-lab type 8.30H). The vitamin A and the other additives (oil, emulsifier, color and artificial sweetener) were incorporated into the gum solution, to which a 2% (w/w) GDL solution was later added. The mixture was poured into a plastic container (10×10×8 cm) and allowed to set. After 48 h, gels were freeze-dried to produce the desired cellular solids.

TABLE 3
Compressibility Parameters Of Freeze-Dried Cellular Solid Matrices
With And Without Internally Produced Gas Bubbles

| Immersion | | | | |
|---|---|---|---|---|
| time (h) with | | | | |
| alginate 1% | C₁ (kPa) | C₂ (−) | C₃ (−) | MSE^{a} |
| 0 | 1180 | 18 | 1.8 | 104 |
| 0.8 | 3520 | 56 | 2.0 | 21 |
| 1.8 | 1690 | 36 | 1.8 | 16 |

MSE^{a} mean square error. C₁, C₂ and C₃ are constants from 3 q: #3

The constants C₁, C₂ and C₃, as previously mentioned, were determined by a nonlinear regression procedure that is based on minimizing the mean of the squared deviations.

TABLE 4
Physical Properties Of Soya Vegetable Oil*

| | |
|---|---|
| Specific gravity (kg/m³) | 0.91 |
| Iodine number | 120-141 |
| Refractive index | 1.467-1.470 |
| Saponification number | 188-195 |
| % Unsaponified matter | 0.5-1.6 |
| % Free fatty acids | 0.02-0.1 |
| Peroxide value (meq/kg) | 1.0 max |
| % Moisture | 0.1 max |
| Melting point | −21° C. ± 1 |
| Smoking point | 450-460° F. |
| Flash point | 635-645° F. |
| Fire point | 700-710° F. |

*Provided by the manufacturer

TABLE 5
Compressive Mechanical Properties Of Alginate-Oil Gels*

| % Oil | Failure stress | | Deformability | |
|---|---|---|---|---|
| (w/w) | (kPa) | Hencky's strain (−) | modulus (kPa) | R² of σ vs. ε |
| 0 | 13.1 ± 0.2 | 0.65 ± 0.02 | 10.3 ± 0.3 | 0.993 |
| 10 | 11.9 ± 0.6 | 0.55 ± 0.08 | 8.5 ± 0.5 | 0.981 |
| 20 | 9.5 ± 0.5 | 0.54 ± 0.04 | 6.0 ± 0.6 | 0.988 |
| 30 | 3.9 ± 0.1 | 0.50 ± 0.01 | 3.4 ± 0.6 | 0.996 |
| 40 | 3.6 ± 0.4 | 0.47 ± 0.02 | 2.1 ± 0.1 | 0.991 |

*Each result represents the average of six determinations ± SD.

TABLE 6
Oil Concentration In Oil-Alginate Gels And Cellular Solid Matrices

| Oil content | Oil content in | |
|---|---|---|
| within alginate | gels after heat | Oil in cellular solid matrices |
| gels (%, w/w) | treatment (%, w/w) | (%, w/w) |
| 0 | 0 | 0 |
| 10 | 6 | 40 |
| 20 | 12 | 57 |
| 30 | 18 | 66 |
| 40 | 28 | 75 |

TABLE 7
Model Constants Of Non-Linear Regression In Compression
Stress-Strain Relationships Of Oil-Freeze Dried Gels

| Oil in gels (%, | | | | |
|---|---|---|---|---|
| w/w) | C₁ (MPa) | C₂ (−) | C₃ (−) | MSE^{a} (× 10⁻⁶) |
| 0 | 0.32 | 444 | 0.94 | 1.39 |
| 10 | 0.19 | 65 | 0.93 | 1.35 |
| 20 | 4.10 | 1719 | 0.88 | 3.60 |
| 30 | 0.01 | 5 | 0.76 | 0.78 |
| 40 | 0.52 | 304 | 0.68 | 0.72 |

^{a}MSE mean square error. C₁, C₂ and C₃ are constants from equation. #3

### Example 15

To examine whether additives, such as oil incorporated within the expanded gel are not subjected to oxidation the following experiment was conducted. Cold set alginate was produced in a similar way to what was described in example 14.1% oil was homogenized within the gum solution before its gelification. The gels were immersed in 20% sucrose solution for 24 h. Later gels were freeze-dried. They were kept at 0 and 22% relative humidity. After 6 weeks oil was extracted by petroleum ether after solubilization of the matrix by 1% EDTA. The oxidation index was determined by procedures which were mentioned by Shimada et al., 1991 (J. Agric. Food Chem. 1991, 39,637-641), and Privett and Blank, 1962 (J. Am. Oil Chem. Soc. 1962, 39, 465-469).

It was found that under these conditions the oil does not suffer from oxidation. It is suggested that this result is a consequence of oil total entrapment within the matrix. Other parameters which may strengthen this result are small changes in the wall thickness and reduction in porosity.

### Example 16

Cold set alginate was produced in a similar way to what was described in example 14. Orange or banana pulp were introduced into the gum solution before its gelification in concentrations up to 20%. The gels also included 5% sucrose, β-carotene 500 ppm, sodium bisulfite 1000 ppm, potassium sorbate 500 ppm, sodium benzoate 500 ppm and flavoring material in concentration of 1000 ppm. The final gels were sun dried. The resultant fruit-cellular solids were condensed due to catastrophic collapse of the gel under this method of drying.

### REFERENCES

Attenburrow, G. E., Goodband, R. M., Tylor, L. J., Lillford, P. J. 'J. Cereal Science 9, 61-70, 1989.

Gibson, L. J. and Ashby, M. L. (1988) Cellular Solids: Structure and Properties; 357 pages, Pergamon Press, Oxford, UK.

Nussinovitch, A., Velez-Silvestre, R. and Peleg, M. (1993). Compressive characteristics of freeze-dried agar and alginate gel cellular solids. Biotechnology Progress, 9, 101-104.

Nussinovitch, A., Peleg, M. and Normand, M. D. (1989). A modified Maxwell and a non-exponential model for characterization of the stress relaxation of agar and alginate gels. J. Food Science, 54, 1013-1016.

Swyngedau, S., Nussinovitch, A., Roy, I., Peleg, M. and Huang, V. (1991) J. Comparison of four models for the compressibility of breads and plastic foams. Food Science, 56, 756-759.

Swyngedau, S., Nussinovitch, A. and Peleg, M. (1991a). Models for the compressibility of layered polymeric cellular solids. Polymer Engineering Science, 31, 140-144.

It will be appreciated by a person skilled in the art that the present invention is not limited by what has been particularly shown and described hereinabove. Rather, the scope of the invention is defined by the claims that follow.

What is claimed is:

1. A method for the production of a cellular solid matrix having predetermined characteristics of moisture absorption, biodegradability, pore size, pore density, pore distribution and structure, said method comprising:
a. providing a hydrocolloid gel solution;
b. expanding the hydrocolloid gel solution with a gas prior to or during gelation, wherein said gas becomes entrapped as bubbles within the matrix of said gel, and wherein said gel keeps its integrity; and
c. drying said expanded gel,
wherein said hydrocolloid gel is selected from the group consisting of agar, agarose, pectin, carrageenan, alginate, gelatin, gellan, konjak mannan, xanthan gum plus locust bean gum, or a combination thereof.

2. The method of claim 1, further comprising freezing the expanded gel prior to its drying.

3. The method of claim 1, wherein the concentration of said hydrocolloid in the solution prior to expansion and drying of the gel does not exceed 20%.

4. The method of claim 1, wherein said gas is produced by microorganisms incorporated within the hydrocolloid gel, said microorganisms are capable of producing a gas by fermentation.

5. The method of claim 4, wherein said microorganisms are yeast or bacteria.

6. The method of claim 1, wherein said gas is released following a chemical reaction between a carbonate salt and an acid incorporated within the gel, said carbonate salt and acid are added simultaneously or consecutively, said gas is being entrapped within the hydrocolloid gel to produce the expanded gel.

7. The method of claim 6, wherein said acid is incorporated within the gel following by a diffusion of the carbonate salt into the gel.

8. The method of claim 6, wherein said carbonate salt is incorporated within the gel followed by a diffusion of the acid into the gel.

9. The method of claim 6, wherein said carbonate salt is calcium carbonate.

10. The method of claim 6, wherein said acid is citric acid.

11. The method of claim 1, wherein said gas is released into a sealed chamber containing the gel, said chamber is optionally filled with fluid, said gas being compressed into said chamber, said chamber being opened abruptly causing said gas to be dissolved and entrapped within the hydrocolloid gel to produce the expanded gel.

12. The method of claim 11, wherein said gas is carbon dioxide, oxygen, nitrogen, a noble gas or air.

13. The method of claim 1, wherein said gas is released using an air sparger.

14. The method of claim 13, wherein said gas is carbon dioxide, oxygen, nitrogen, a noble gas or air.

15. The method of claim 1, wherein said hydrocolloid gel solution further comprises an emulsifier.

16. The method of claim 15, wherein said emulsifier is selected from the group consisting of natural emulsifier, synthetic emulsifier and semi-natural emulsifier.

17. The method of claim 16, wherein said natural phospholipid is selected from the group consisting of lecithin; phosphatidylcholine, phosphatidylethanolamine, sphingomyelin, purified egg yolk phospholipids and soybean oil phospholipids.

18. The method of claim 1, wherein said drying comprises lyophilization, vacuum drying, fluidized bed drying, sun drying or oven drying.

19. The method of claim 1, further comprising adding an oil or fat to said hydrocolloid gel solution.

20. The method of claim 19, wherein said oil or fat is added prior to the expanding of said gel with the gas.

21. The method of claim 20, wherein the addition of said oil or fat reduces the porosity of said cellular solid matrix.

22. The method of claim 1, further comprising incorporating within said hydrocolloid gel solution water, a flavor, a coloring material, a plasticizer, a salt, a preservative, an acidifying agent, a polysaccharide or a modified polysaccharide, a sweetener, a sequestering agent, a filler, a cross linking agent, a food additive, a high calorie food ingredient, a low calorie food ingredient, a biological material, microorganisms, a drug or a combination thereof.

23. The method of claim 22, wherein said food additive comprises at least one vitamin.

24. The method of claim 22, wherein said biological material comprises an enzyme and a biological substrate for an enzyme.

25. The method of claim 24, wherein said enzyme is incorporated within the hydrocolloid gel prior to its expansion and the biological substrate is diffused through the gel in a later stage in order to start the enzymatic reaction.

26. The method of claim 24, wherein said biological substrate is incorporated within the hydrocolloid gel prior to its expansion and the enzyme is diffused through the gel in a later stage in order to start the enzymatic reaction.

27. The method of claim 25, wherein said enzyme is diffused within the surface of the hydrocolloid gel, thereby decomposing the substrate on the surface of said gel.

28. The method of claim 22, wherein said microorganisms are bacteria, yeast or fungi.

29. The method of claim 24, wherein said enzyme is a lipase and said substrate is oil.

30. The method of claim 24, wherein said enzyme is an industrial blend of pectolytic enzymes and said substrate is pectin.

31. A biodegradable cellular solid matrix having predetermined characteristics of moisture absorption, biodegradability, pore size, pore density, pore distribution and structure, said cellular solid is produced by:
a. expanding a hydrocolloid gel solution with a gas, wherein said gas becomes entrapped as bubbles within the matrix of said gel, and wherein said gel keeps its integrity; and
b. drying said expanded gel,
wherein said hydrocolloid gel is selected from the group consisting of agar, agarose, pectin, carrageenan, alginate, gelatin, gellan, konjak mannan, xanthan gum plus locust bean gum, or a combination thereof.

32. The cellular solid matrix of claim 31, wherein said gas is produced by microorganisms incorporated within the hydrocolloid gel, said microorganisms are capable of producing a gas by fermentation.

33. The cellular solid matrix of claim 32, wherein said microorganisms are yeast or bacteria.

34. The cellular solid matrix of claim 31, wherein said gas is released following a chemical reaction between a carbonate salt and an acid incorporated within the gel, said gas is being entrapped within the hydrocolloid gel to produce the expanded gel.

35. The cellular solid matrix of claim 31, wherein said gas is released into a sealed chamber containing the gel, said gas being compressed into said chamber, said chamber being opened abruptly causing said gas to be dissolved and entrapped within the hydrocolloid gel to produce the expanded gel.

36. The cellular solid matrix of claim 35, wherein said gas is carbon dioxide, oxygen, nitrogen, a noble gas or air.

37. The cellular solid matrix of claim 31, wherein said hydrocolloid gel solution comprises an emulsifier.

38. The cellular solid matrix of claim 37, wherein said emulsifier is selected from the group consisting of natural emulsifier, synthetic emulsifier and semi-natural emulsifier.

39. The cellular solid matrix of claim 38, wherein said natural phospholipid is selected from the group consisting of lecithin; phosphatidylcholine, phosphatidylethanolamine, sphingomyelin, purified egg yolk phospholipids and soybean oil phospholipids.

40. The cellular solid matrix of claim 31, wherein said cellular solid matrix further comprising water, a flavor, a coloring material, a cross linking agent, a plasticizer, a salt, a preservative, an acidifying agent, a water-soluble polymer, a sweetener, a sequestering agent, an oil, a filler, a food additive, a high calorie food ingredient, a low calorie food ingredient, a biological material, microorganisms, a pharmaceutical drug or a combination thereof.

41. The cellular solid matrix of claim 40, wherein said biological material comprises an enzyme and a biological substrate for enzymatic reaction.

42. The cellular solid matrix of claim 41, wherein said enzyme is a lipase and said substrate is oil or fat.

43. The cellular solid matrix of claim 41, wherein said enzyme is an industrial blend of pectolytic enzymes and said substrate is pectin.

44. The cellular solid matrix of claim 40, wherein said cellular solid comprises an oil in the amount of up to 40% of the initial solution.

45. The cellular solid matrix of claim 40, wherein said pharmaceutical drug is a lipophilic drug or a lipophilic vitamin.

46. The cellular solid matrix of claim 31 for use as a carrier for an edible material.

47. The cellular solid matrix of claim 46, wherein said edible material is a food additive, a high calorie food ingredient, or a low calorie food ingredient.

48. The cellular solid matrix of claim 31 for use as a carrier for a pharmaceutical drug.

49. The cellular solid matrix of claim 31 for use as a moisture absorbent.

50. The cellular solid matrix of claim 31 for use as a biodegradable packaging material.

51. The cellular solid matrix of claim 31 for use as a carrier for microorganisms.

52. A method for the production of a cellular solid matrix comprising:
(a) mixing a hydrocolloid gum with an oil at a temperature above the gel setting point to form a hydrocolloid gel;
(b) heating said hydrocolloid gel comprising the oil at a temperature below the gel melting point until the removal of the oil from the gel, thereby forming pores in place of the oil, and
(c) drying the gel of step (b),
wherein said hydrocolloid gel is selected from the group consisting of agar, agarose, pectin, carrageenan, alginate, gelatin, gellan, konjak mannan, xanthan gum plus locust bean gum, or a combination thereof.

53. A method for the production of a cellular solid matrix comprising:
(a) mixing a hydrocolloid gel with sodium iodide in conditions which permit partial dissolution of the gel to form pores in the gel; and
(b) drying the gel of step (a).

54. The method of claim 53, wherein said hydrocolloid gel is agar or agarose or a blend of agar or agarose with at least one hydrocolloid selected from the group consisting of pectin, carrageenan, alginate, gelatin, gellan, konjak mannan, and xanthan gum plus locust bean gum.
